(19) United States
(12) Patent Application Publication
(10) Pub. No.: US 2018/0375762 A1
(43) Pub. Date: Dec. 27, 2018

(54) SYSTEM AND METHOD FOR LIMITING ACCESS TO CLOUD-BASED RESOURCES INCLUDING TRANSMISSION BETWEEN L3 AND L7 LAYERS USING IPV6 PACKET WITH EMBEDDED IPV4 ADDRESSES AND METADATA

(71) Applicant: Microsoft Technology Licensing, LLC, Redmond, WA (US)

(72) Inventors: Deepak BANSAL, Bellevue, WA (US); Parag SHARMA, Issaquah, WA (US); Nimish AGGARWAL, Redmond, WA (US); Longzhang FU, Bellevue, WA (US); Harish Kumar CHANDRAPPA, Bothell, WA (US); Daniel FIRESTONE, Seattle, WA (US); Shekhar AGARWAL, Bellevue, WA (US); Anitha ADUSUMILLI, Redmond, WA (US)

(21) Appl. No.: 15/628,847

(22) Filed: Jun. 21, 2017

(51) Int. Cl. H04L 12/741; H04L 29/06; H04L 12/911; H04L 29/12; G06F 9/455

(52) U.S. Cl. CPC H04L 45/74; H04L 69/22; H04L 47/70; G06F 2009/45587; G06F 9/45558; G06F 2009/45595; H04L 61/251

(57) ABSTRACT

A system is provided and includes a processor and a non-transitory computer-readable medium configured to store instructions for execution by the processor. The instructions include: accessing a resource via a first machine in a cloud-based network, where the first machine is a virtual machine; converting at the first machine an IPv4 packet to a IPv6 packet; while converting the IPv4 packet, embedding metadata in the IPv6 packet, where the metadata includes information identifying the first machine or a virtual network of the first machine; and transmitting the IPv6 packet to a second machine to limit access to the resource based on the information identifying the the first machine or the virtual network of the first machine. The second machine limits access to the resource based on the information identifying the at least one of the first machine or the virtual network of the first machine.

### FIELD

The present disclosure relates to controlling access to cloud-based resources.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Cloud-based networks allow computer processing and storing needs to be moved from on premises networks to hybrid cloud or fully cloud-based networks while satisfying data security access requirements. A cloud-based network may include physical machines (PMs) and virtual machines (VMs). Cloud applications may be implemented via the PMs and/or the VMs. The cloud applications can be accessed from client stations of organizations at remote locations.

### SUMMARY

A system is provided and includes a processor and a non-transitory computer-readable medium configured to store instructions for execution by the processor. The instructions include: accessing a resource via a first machine in a cloud-based network, where the first machine is a virtual machine; converting at the first machine an IPv4 packet to a IPv6 packet; while converting the IPv4 packet, embedding metadata in the IPv6 packet, where the metadata includes information identifying at least one of the first machine or a virtual network of the first machine; and transmitting the IPv6 packet to a second machine to limit access to the resource based on the information identifying the at least one of the first machine or the virtual network of the first machine. The second machine limits access to the resource based on the information identifying the at least one of the first machine or the virtual network of the first machine.

In other features, a system and includes a processor and a non-transitory computer-readable medium configured to store instructions for execution by the processor. The instructions include: receiving at a first machine an IPv6 packet from a second machine, where the IPv6 packet includes an IPv4 source address, an IPv4 destination address and metadata, where the metadata includes information identifying at least one of the second machine or a virtual network of the second machine, and where the second machine is a virtual machine; removing the metadata from the IPv6 packet; and applying an access control list at a traffic controller providing access to a shared resource of a cloud-based network. The access control list includes one or more rules limiting access to a resource based on the information identifying at least one of the second machine or the virtual network of the second machine.

In other features, a non-transitory computer-readable medium storing processor-executable instructions. The instructions include: accessing a resource via a first machine in a cloud-based network, where the first machine is a virtual machine; converting at the first machine an IPv4 packet to an IPv6 packet; while converting the IPv4 packet, embedding information in the IPv6 packet, where the information identifies at least one of a virtual network, a subnet or an Internet protocol address of the first machine; and transmitting the IPv6 packet to a second machine to limit access to the resource based on the information identifying the at least one of the virtual network, the subnet or the Internet protocol address of the first machine. The second machine limits access to the resource based on the information identifying the at least one of the virtual network, the subnet or the Internet protocol address of the first machine.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a functional block diagram of an example of a resource management system including a resource management application in accordance with an embodiment of the present disclosure.

FIG. 2 is a functional block diagram of an example of a portion of the resource management system of FIG. 1 illustrating examples of a source machine and a destination machine operating according to an embodiment of the present disclosure.

FIG. 3 is a functional block diagram of an example of a cloud-computing system illustrating a resource manager, one or more fabric controllers, and one or more load balancers operating according to an embodiment of the present disclosure.

FIG. 4 is a simplified example of a cluster shown in FIG. 3.

FIG. 5 is a functional block diagram of an example of a client computer in accordance with an embodiment of the present disclosure.

FIG. 6 is a functional block diagram of an example of a server computer incorporating applications in accordance with an embodiment of the present disclosure.

FIG. 7 illustrates an example of a method of operating a source machine in accordance with an embodiment of the present disclosure.

FIG. 8 is a packet conversion and metadata extraction diagram in accordance with an embodiment of the present disclosure.

FIG. 9 illustrates an example of a method of operating a destination machine in accordance with an embodiment of the present disclosure.

In the drawings, reference numbers may be reused to identify similar and/or identical elements.

### DETAILED DESCRIPTION

Below are simplistic examples of a distributed computing environment in which the systems and methods of the present disclosure can be implemented. Throughout the description, references to terms such as servers, client devices, applications and so on are for illustrative purposes only. The terms server and client device are to be understood broadly as representing computing devices with one or more processors and memory configured to execute machine readable instructions. The terms application and computer program are to be understood broadly as representing machine readable instructions executable by the computing devices.

A cloud-based network includes resources. A portion of the resources may be allocated to a customer and accessed by machines of the customer using a public Internet protocol (IP) address and a corresponding one or more keys. Any machine that has the one or more keys to access the public IP address can gain access to the allocated resources.

Examples set forth herein provide systems and methods of limiting access of customer allocated resources to one or more applications executed on one or more machines of the customer. The applications may be implemented in a cloud-based network. Access is prevented to other applications and machines. This limited access is provided for resources, such as databases, data storage, files, virtual machines, applications, etc. This limited access provides a layer of protection for customer data stored in publicly accessible databases and data storage.

The examples include converting Internet protocol version 4 (IPv4) packets to Internet protocol version 6 (IPv6) packets and embedding metadata in headers of the IPv6 packets. The metadata includes information indicating where the IPv4 packets originated, which is then used to apply a policy of an access control list (ACL) on, for example, a host node of a service provider providing the services. The IPv6 packets are transmitted between a L3 layer of a source machine and a L7 layer of a destination machine. The L3 and L7 layers refer to network and application layers of the Open Systems Interconnection (OSI) model. The metadata provides additional information, not included in a traditional IPv4 packet. After the IPv6 packets are transmitted to the destination machine, the additional information allows the IPv6 packets to be forwarded between applications and/or used to limit access to resource based on ACL(s). Metadata transmission examples disclosed herein are applicable to implementations other than the implementations of limiting access to resources based on ACL(s). The other implementations are described below.

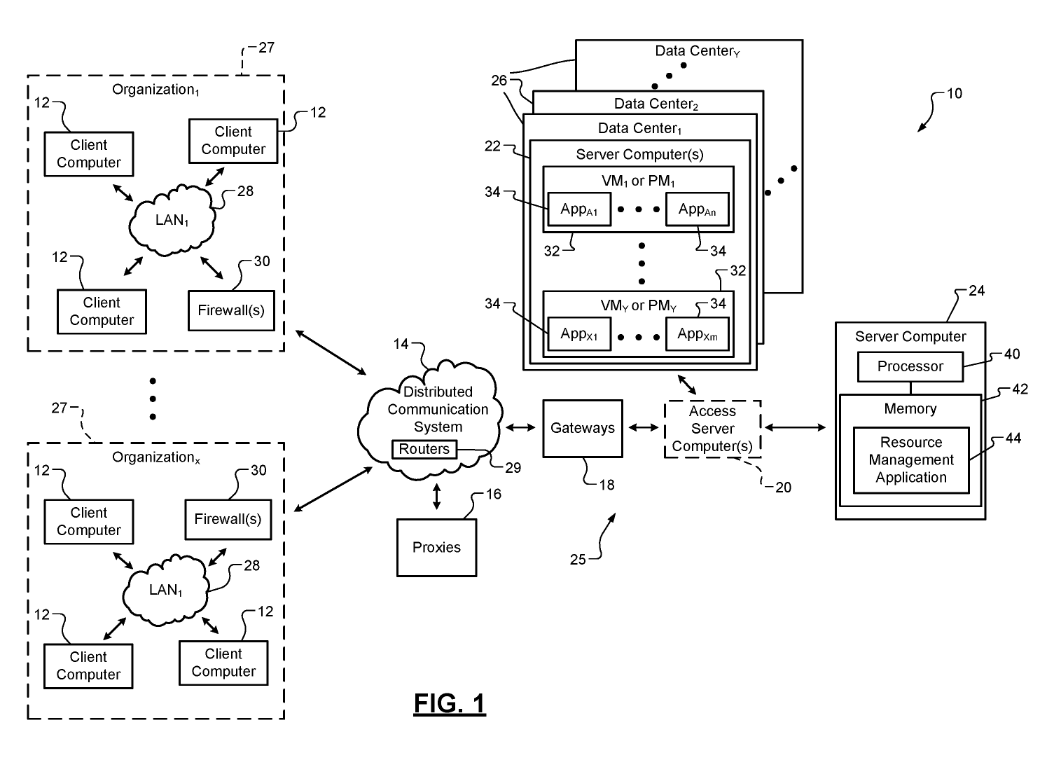

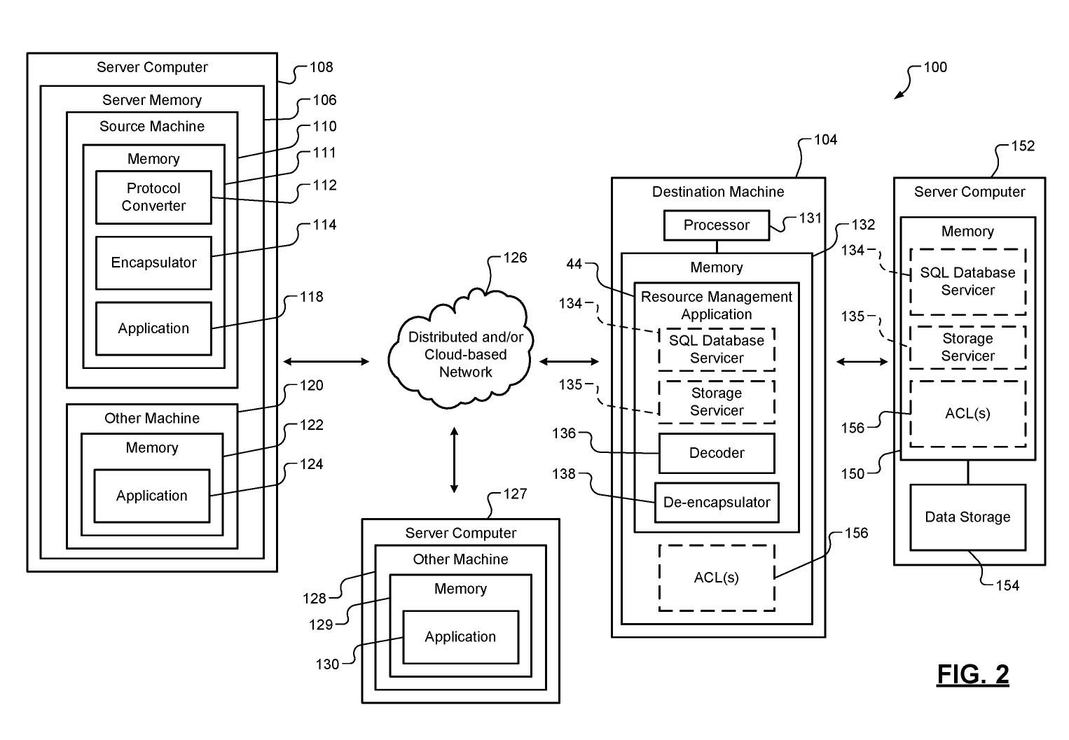

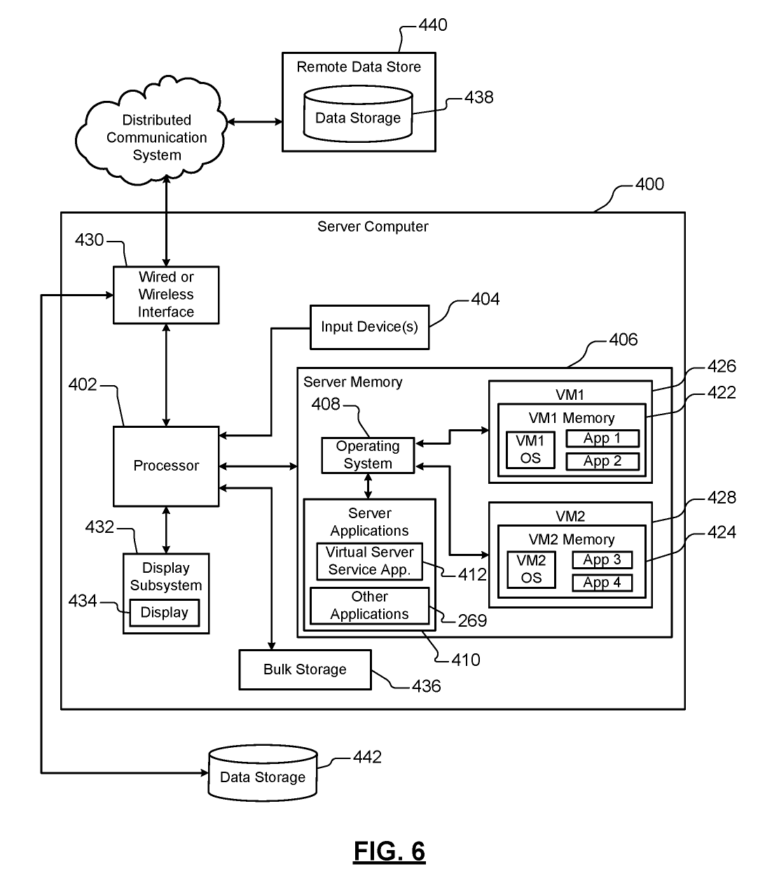

FIG. 1 shows a resource management system 10 that includes client computers 12, a distributed communication system 14, proxies 16, gateways 18, one or more access server computers 20, and other server computers 22, 24. In some examples, the gateways 18, one or more access server computers 20, and one or more server computers 22 are implemented in a cloud-based network 25. The server computers 22, 24 may be implemented in data centers; example data centers 26 are shown. Each of the data centers may include data storage and any number of server computers. Example data storage is shown in FIGS. 2 and 6. The data centers may be located in corresponding geographical regions, where each geographical region refers to: geographical areas of one or more businesses; one or more towns; one or more cities; one or more states; one or more countries; a continent; and/or other geographical area. In some examples, the server computer 24 is implemented in the cloud-based network 25 or in another service provider network. In another example, the access server computers 20 are not included in the resource management system 10 and the gateways 18 communicate directly with the server computers 22, 24. In the example shown, the client computers are owned by corresponding organizations 27 (also referred to as customers). The organizations 27 may include local area networks (LANs) 28 and firewalls 30. The client computers 12 may access the distributed communication system 14 directly and/or via the LANs 28 and firewalls 30. The distributed communication system 14 may include routers 29. One or more of the organizations 27 may include multiple LANs and corresponding client computers, where each LAN and corresponding client computers are located in a corresponding one of the geographical regions of the data centers 26.

The cloud-based network 25 may be implemented by a cloud service provider and, in an embodiment, includes client virtual machines, network appliances and application server computers. Examples of network appliances include routers, switches, firewalls, proxy server computers, World Wide Web (or Web) server computers, wide area network (WAN) accelerators, intrusion detection system (IDS) devices, and intrusion prevention system (IPS) devices. The network appliances provide intermediary services between the application server computers and client computers. The client computers 12 can be implemented in the cloud-based network 25 as VMs and/or PMs 32 or can be located on premises. The network appliances and application server computers may be implemented as one or more VMs of the cloud-based network 25.

The cloud-based network 25 may include one or more of the server computers 22, 24. The cloud-based network 25 further includes resources that may be shared by the client computers 12. The cloud service provider provisions the resources, such as software applications having corresponding executable code, server computer processing time, server computer processor speed, data storage, VMs, PMs, and/or other resources to tenants (e.g., customers and/or businesses) via the cloud-based network 25. The resources may include user management tools, security application resources, or other resources. A tenant may have one or more subscriptions. A subscription may refer to, for example, rental of one or more resources, a container, a set of machines, a logic subset of machines of a business, and/or a business unit. A business unit includes a set of PMs and/or VMs of a tenant. Cloud service providers implement infrastructure as a service (IaaS) and platform as a service (PaaS) using VMs or containers. A container includes processing, storage and application resources. Data centers may include server computers that host the VMs or containers. Each server can host many VMs and/or containers. The VMs run on a guest operating system and interface with a hypervisor, which shares and manages server hardware and isolates the VMs. Unlike VMs, containers do not need a full OS to be installed or a virtual copy of the host server's hardware. Containers may include a few software modules and libraries and require the use of some portions of an operating system. As a result of the reduced footprint, many more containers can be deployed on a server as compared to virtual machines. The server computers 22, 24 may include VMs (e.g., VMs_{1-Y} are shown), which may be implemented as PMs (e.g., PMs_{1-Y}). The software applications may be implemented on the server computers 22, 24, which may be referred to as physical machines.

The client computers 12 may be privately owned by different individuals and/or entities. In the example shown, the client computers 12 are owned by organizations 27. Each of the client computers 12 may access one or more cloud applications 34 stored in the server computers 22 and/or VMs 32. The organizations 27 may own and/or have paid access to corresponding ones of the VMs 32 and/or cloud applications 34. The client computers 12 may include desk/laptop computers, tablets, mobile phones, wearable devices, access terminals, and/or other network devices for accessing the cloud applications 34. Accessing of the cloud applications 34 may include: communicating with the cloud applications 34; transferring data, packets, information, etc. between the client computers 12 and the server computers 22 in association with the cloud applications 34; modifying and/or updating the cloud applications; and/or uploading and/or downloading the cloud applications 34 and/or files associated with the cloud applications 34.

The distributed communication system 14 may include routers, switches and/or other network devices for directing data and/or packets between (i) the client computers 12 and/or organizations 27 and (ii) the gateways 18. The distributed communication system 14 may include a network, such as a local area network (LAN), a wireless local area network (WLAN), and/or a wide area network (WAN) (e.g., the Internet). The proxies 16 may transfer data, packets, information, etc. between the firewalls 30 and the gateways 18. In an embodiment, the proxies 16 are implemented as part of the distributed communication system 14. The gateways may transfer data, packets, information, etc. between the distributed communication system 14 and the access server computers 20. The access server computers 20 may provide access to direct communication with the server computers 22 and/or the server computer 24. In one embodiment, the access server computers 20 are implemented as client access server computers and facilitate providing services, such as services associated with software as a service (SaaS) applications, from the server computer 24 to the client computers 12. The gateways 18, the access server computers 20, the server computers 22 and/or the server computer 24 may be implemented in an internal network of a service provider that provides software applications.

The server computer 24 includes a processor 40 that executes software applications, such as a security application and/or a resource management application 44, as shown. The resource management application 44 is stored in memory 42. One or more of the VMs 32 and/or other resources to be allocated to customers may be implemented in the server computer 24. The resource management application 44 may be provided as a service application by the service provider and used to monitor and control traffic flow to cloud applications implemented in the cloud-based network 25. The resource management application 44 monitors behavior of the client computers 12, users of the client computers 12 and/or VMs and PMs of customers directed to access of the cloud applications 34 and VMs/PMs 32. The VMs and PMs of the customers may include the VMs and PMs 34 and/or on premises VMs and PMs. The client computers 12 may access the resource management application 44 via a web browser and corresponding website. The resource management application 44 may monitor, for example, traffic between client computers of organizations, accessed cloud applications, VMs and PMs.

The resource management application 44 may receive IPv6 packets having embedded metadata, which the resource management application 44 may then use when applying ACLs at host nodes, server computers, and/or traffic controllers to limit access to resources. Examples of traffic controllers are fabric controllers, allocators, load balancers, storage servers, SQL database servicers, etc. This is further described below. Examples of host nodes, server computers, fabric controllers, allocators, load balancers, a storage and SQL database servicer are shown in FIGS. 1-4. The resource management application 44 may be implemented in the cloud-based network 25 and/or a network of a service provider and is used to monitor activity between (i) client computers and (ii) VMs and/or PMs of the cloud applications. The resource management application 44 may also monitor traffic between VMs and/or PMs in the cloud-based network 25 and/or located on premises. Operations of the resource management application 44 are further described below with respect to at least FIGS. 2 and 6-9.

FIG. 2 shows a portion 100 of the resource management system 10 of FIG. 1 and includes a source machine 102 and a destination machine 104. The machines 102, 104 may each be a VM or a PM. As an example, the source machine may be a VM implemented in a server computer 108 of the cloud-based network 25 and the destination machine 104 is implemented as a server computer having the resource management application 44. In one embodiment, the destination machine 104 may create and provide ACLs to traffic controllers. As another example, the destination machine 104 may be a traffic controller, such as that in a host node or a server computer and enforce the created ACL(s). In yet another embodiment, a server computer of a service provider other than the server computer of the destination machine 104 may create and provide ACL(s) to traffic controllers. As a few examples, the traffic controllers may be a fabric controller, an allocator, a load balancer, or a storage and/or SQL database servicer.

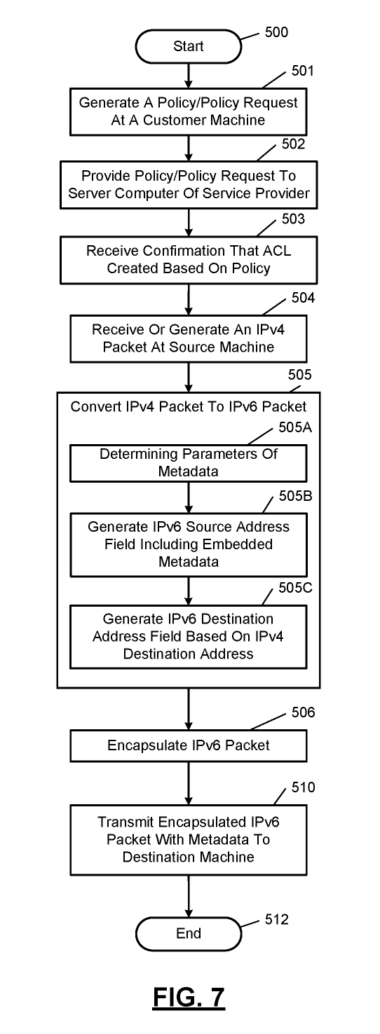

As shown, the source machine 102 may be implemented in a server memory 106 of the server computer 108. The server computer 108 may be one of the server computers 22 of FIG. 1. The source machine 102 may include memory 111. In one embodiment, the source machine 102 is implemented as a VM and the memory 111 is VM memory. The memory 111 includes a protocol converter 112, an encapsulator 114, and may include one or more applications (one application 118 is shown). The protocol converter 112 and the encapsulator 114 may be implemented in a L3 layer of the server computer 108. Operations of the protocol converter 112 and encapsulator 114 are described below with respect to the method of FIG. 7.

The server memory 106 may include one or more other machines (one other machine 120 is shown). The other machine 120 may include a memory 122 and one or more applications (e.g., application 124). The source machine 110 may be in communication with the destination machine 104 via a distributed network and/or a cloud-based network (shown as “distributed and/or cloud-based network 126). The other machine 120 may be located separate from the server memory 106 and/or server computer 108. As an example, a server computer 127 including machine 128, which has memory 129 is shown. The memory 129 may store one or more applications (e.g., application 130).

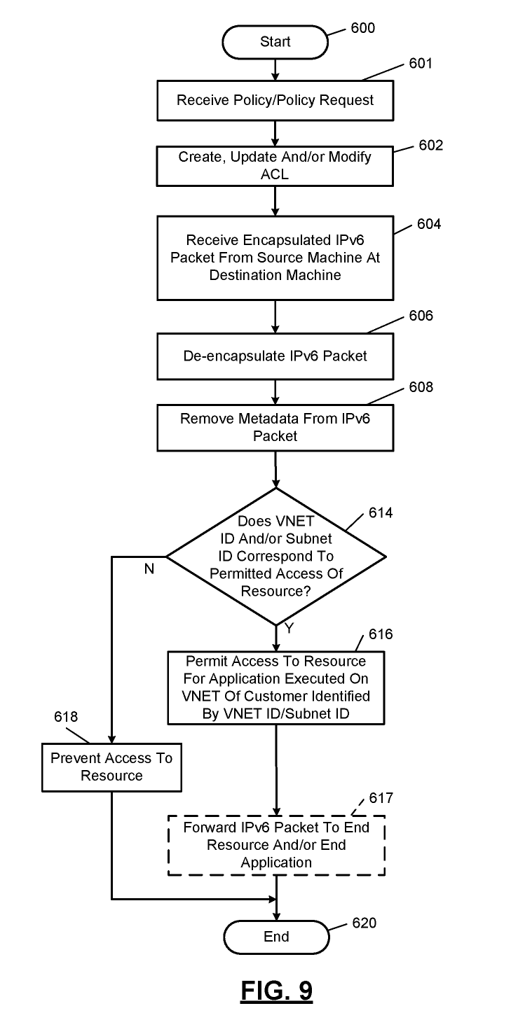

As shown, the destination machine 104 may be a physical machine and replace the server computer 24 of FIG. 1. The destination machine 104 includes a processor 131 and a memory 132. The memory 132 may include the resource management application 44. In one embodiment, the resource management application 44 includes a structured query language (SQL) database servicer 134, a storage servicer 135, a decoder 136, and a de-encapsulator 138. Operations of the SQL database servicer 134, the storage servicer 135, the decoder 136, and the de-encapsulator 138 are described below with respect to the method of FIG. 9.

Although the SQL database servicer 134 and the storage servicer 135 are shown as being part of the resource management application 44, stored in the memory 132 of the destination machine 104, the SQL database servicer 134 and the storage servicer 135 may be located in a different memory, a different machine and/or a different server computer than the resource management application 44. As an example, the SQL database servicer 134 and the storage servicer 135 may be stored in a memory 150 of a server computer 152. The server computer 152 may include a data storage 154 and/or have access to a data storage. The server computer 152 may be one of the service computers 22 of FIG. 1.

The resource management application 44, the SQL database servicer 134, and/or the storage servicer 135 may limit access to the data storage 154 and/or other resources of the cloud-based network 25 based on one or more ACL(s) 156 placed in one or more of the memory 132, the memory 150 and/or other memory. The terms “placed”, “place”, “placing”, “put” and “putting” may refer to: creating and storing an ACL; modifying a previously created ACL; and/or updating of one or more rules of a previously created ACL. The ACL(s) may be initially created and placed by a server computer of a service provider based on a policy generated at and/or a policy request received from a customer machine via a web browser. The web browser may be implemented at a client computer, a customer machine, and/or source machine (e.g., one of the client computers 12, the machines 32 and/or the source machine 110 of FIGS. 1-2).

After the ACL(s) are created, the ACL(s) may be applied based on information embedded in IPv6 packets. The source machine 110 may generate the IPv6 packets and transmit the IPv6 packets to the destination machine 104. The information may include header information in the IPv6 packets including IPv4 destination addresses and metadata. The metadata may include: a geographical location of the source machine 110; network capabilities (e.g., transmission speed, communication protocols, packet types, types of encoding, etc.) of the source machine 110; a virtual network (VNET) identifier (ID) of a VNET of a customer, a subnetwork (subnet) ID of a portion of the VNET, an IP address of a customer VM, etc. The IP address (or medium access control (MAC) address) of the customer VM is specific to the customer VM and is different than an IPv4 destination address (or MAC address) of a physical machine. A VNET may include any number of VMs, containers, ports, etc. allocated to a customer. A subnet may include any number of the VMs, containers, ports, etc. of a VNET. A VNET may include any number of subnets. The geographical location of the source machine 110 may be used for service provider billing purposes. The network capabilities may be used to maximize connectivity performance with destination machine 104.

In limiting access, the resource management application 44, the SQL database servicer 134, and/or the storage servicer 135 may permit, for example, the application 118 to access the data storage 154 and/or other resources of the cloud-based network 25 associated with a customer based on the placed ACL. The resource management application 44, the SQL database servicer 134, and/or the storage servicer 135 may permit one or more other applications associated with the same customer to access the data storage 154 and/or other resources of the cloud-based network 25. The resource management application 44, the SQL database servicer 134, and/or the storage servicer 135 may prevent the application 124 and/or the application 130 from accessing the data storage 154 and/or other resources of the cloud-based network 25. The data storage 154 and/or other resources of the cloud-based network 25 may further limit access to a particular VNET, a particular subnet, and/or a particular machine based on the metadata.

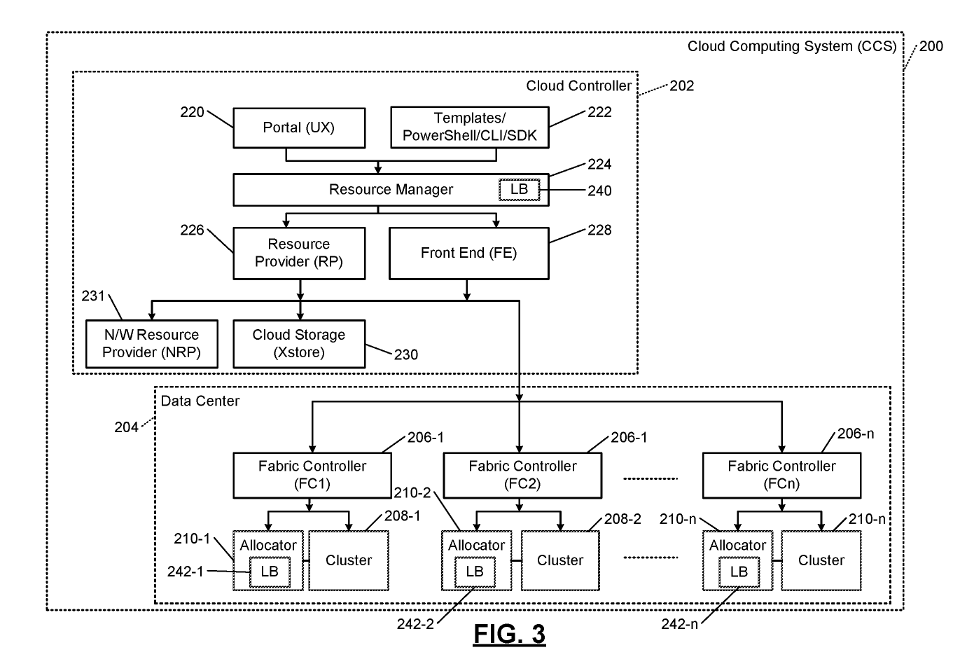

FIG. 3 shows an example of a cloud-computing system (CCS) 200 that includes a cloud controller 202 and at least one data center 204, which may be one of the data centers 26 of FIG. 1. While only one data center is shown for simplicity, the cloud controller 202 can interface with multiple data centers, where each data center may be configured similarly. Further, while the data center 204 is shown as being local to the cloud controller 202, one or more data centers may be geographically remote from the cloud controller 202, may be located in different geographic locations (e.g., in different time zones, different countries or continents, etc.), and may communicate with the cloud controller 202 via various networks. The cloud controller 202 controls the one or more data centers.

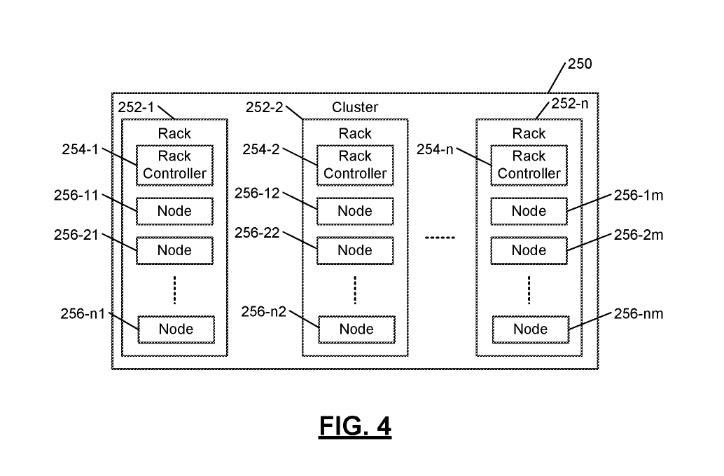

The data center 204 includes fabric controllers 206-1, 206-2, . . . , and 206-n (collectively fabric controllers 206) and corresponding clusters 208-1, 208-2, . . . , and 208-n (collectively clusters 208). Each fabric controller 206 controls a respective cluster 208. Each cluster 208 includes racks (shown in FIG. 4), and each rack includes nodes (shown in FIG. 4). Each node may include one or more server and/or host computers, where each server and/or host computer includes one or more machines. Each fabric controller 206 may include or be associated with an allocator 210 that allocates resources within the cluster 208 for instances of customer services hosted on the cluster 208.

The cloud controller 202 includes a portal 220 and a software development kit (SDK) 222 that the customers can use to select resources and request service deployment. The cloud controller 202 further includes a resource manager 224, a resource provider 226, and a front-end 228. The resource manager 224 may execute the resource management application 44 of FIGS. 1-2. The front-end 228 interfaces with the fabric controllers 206 of one or more data centers 204. The resource manager 224 receives the customer selections and forwards the customer selections to the resource provider 226. The resource provider 226 generates a tenant model based on the customer selections. The resource provider 226 provisions resources to the customer services according to the tenant model generated based on the customer selections. The resource provider 226 provisions storage, networking, and computing resources by interfacing with a cloud storage (Xstore) 230, a network resource provider 231, and the fabric controllers 206. One or more virtual machines (VMs) may be deployed in one of the clusters 208 based on the tenant model.

The resource manager 224 and the allocators 210 may be implemented as or include load balancers 240, 242 for controlling flow of traffic to the fabric controllers 206, the clusters 208, the nodes, and/or the server and/or host computers. One or more of the resource manager 224, fabric controllers 206, allocators 210, and load balancers 240, 242 may limit access to resources based on ACLs. The ACLs may include the ACLs described herein as being placed by the resource management application 44.

FIG. 4 shows a cluster 250, which may be one of the clusters 208 shown in FIG. 4. The cluster 250 includes racks 252. Each of the racks 252 includes a rack controller 254 and nodes 256.

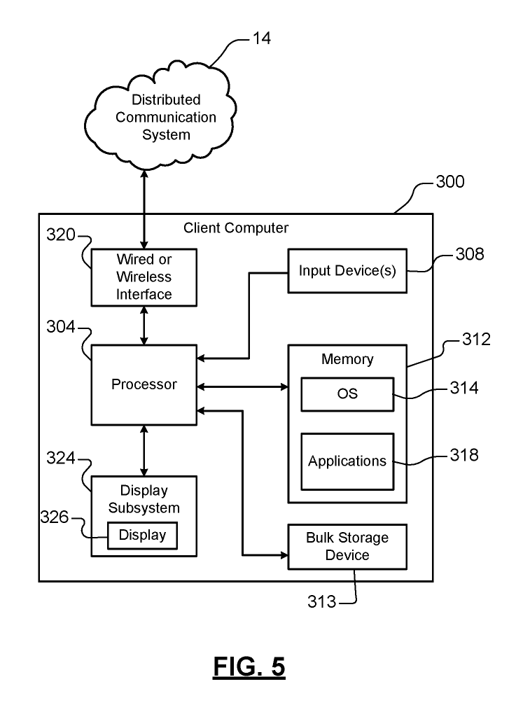

FIG. 5 shows a client computer 300. The client computers 12 of FIG. 1 may be implemented as the client computer 300. The client computer 300 includes a central processing unit (CPU) or processor 304 and an input device 308 such as a keypad, touchpad, mouse, etc. The client computer 300 further includes memory 312 such as volatile or nonvolatile memory, cache or other type of memory. The client computer 300 further includes bulk storage device 313 such as flash memory, a hard disk drive (HDD) or other bulk storage device.

The processor 304 of the client computer 300 executes an operating system 314 and one or more applications 318. For example, the applications 318 may include a web browser as described above. The client computer 300 further includes a wired interface (such as an Ethernet interface) and/or wireless interface (such as a Wi-Fi, Bluetooth, near field communication (NFC) or other wireless interface (collectively identified at 320)) that establishes a communication channel over the distributed communication system 14. The client computer 300 further includes a display subsystem 324 including a display 326.

FIG. 6 shows a server computer 400. The server computers 20, 22, 24 of FIG. 1 may be implemented as and/or have similar architecture as the server computer 400. The server computer 400 includes one or more processors 402 and an input device 404 such as a keypad, touchpad, mouse, etc. The server computer 400 further includes a server memory 406, such as volatile or nonvolatile memory, cache or other type of memory. The processor 402 executes an operating system (OS) 408 and one or more server applications 410 and/or VM applications. Examples of server applications include the resource management application 44 of FIGS. 1-2 and other applications, such as the applications 124, 130 of FIG. 2 and a virtual server service application 412, which is implemented in a virtualization layer and is executed along with the OS 408. The virtual server service application 412 creates a virtual environment in which VM (or guest) OSs (e.g., VM1 OS and VM2 OS) run. Example VM applications App 1, App 2, App 3, and App 4 are shown as being implemented in VM memories 422, 424 of VMs 426, 428, respectively. The VM applications may include instances of auto-generated websites, network appliances, storage applications, productivity applications, and/or other VM applications. VM applications App 1-4 are shown as examples. Each of the VM memories may include one or more VM applications.

The server computer 400 further includes a wired or wireless interface 430 that establishes a communication channel over the distributed communication system 14. The server computer 400 further includes a display subsystem 432 that includes a display 434. The server computer 400 may further include a bulk storage device 436 such as flash memory, a hard disk drive (HDD) or other local or remote storage device. The processor 402 may also access a data storage 438 of a remote data store 440 via the interface 430 and the distributed communication system 14, or a data storage 442, such as a database, via the interface 430.

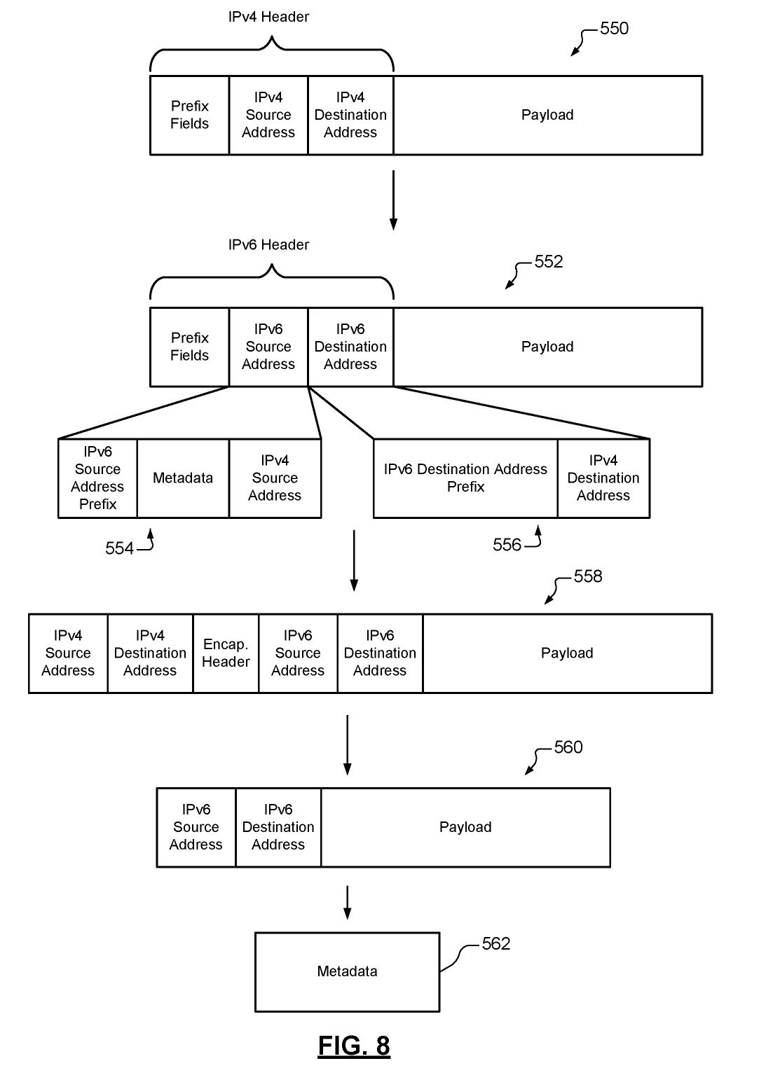

Operations of the source machine 110, the destination machine 104 and the server computer 152 of FIG. 2 are further described below with respect to the methods of FIGS. 7 and 9 and the packet conversion and metadata extraction diagram of FIG. 8. Although the following operations of FIGS. 7 and 9 are primarily described with respect to the implementations of FIGS. 1-6, the operations may be modified to apply to other implementations of the present disclosure. The operations may be iteratively performed. FIG. 7 shows a method of operating the source machine 110. Although the method of FIG. 7 is described with respect to the source machine 110, the method may be implemented by other machines of FIGS. 1-6.

The method begins at 500. At 501, a policy and/or policy request may be generated at a customer machine as described above. The customer machine may receive inputs from a user indicating parameters of the policy. The policy may indicate one or more of each of a geographical region, an IP address of a physical machine, a VNET, a subnet, an IP address of a virtual machine, an ID of an application, etc. for which access is permitted to a resource. Access to the resource may be prevented for all other physical machines, virtual machines, applications, etc. At 502, the policy and/or a corresponding policy request may be provided and/or transmitted to a server computer of a service provider. In one embodiment, the policy and/or corresponding policy request is provided to the resource management application 44. The resource management application 44 may create, update and/or modify an ACL. See task 602 of FIG. 9. At 503, the customer machine may receive a confirmation signal and/or indication that the ACL has been created and that the policy is to be enforced.

At 504, the source machine 110 receives or generates an IPv4 packet, which is to be sent to the destination machine 104. The IPv4 packet may be generated to (i) communicate with an end machine (physical and/or virtual machine) and/or application, (ii) transfer data between the source machine 110 and the end machine (physical and/or virtual machine) and/or application, and/or (iii) request and gain access to the resource. An example of the IPv4 packet is shown as 550 in FIG. 8 and includes an IPv4 header and payload. The IPv4 header includes prefix fields, an IPv4 source address field and an IPv4 destination address field. The prefix fields may include, for example, version, length, identification, flags, protocol, and checksum fields. The address fields include IPv4 addresses of the source machine 110 and the destination machine 104. Each of the IPv4 address fields may be a public address and includes 32 bits. The IPv4 destination address may identify a node and/or node address. In one example embodiment, the IPv4 packet is associated with and/or generated by the application 118. In another embodiment, the IPv4 packet is associated with and/or requests access to a resource.

At 505, the protocol converter 112 converts the IPv4 packet to an IPv6 packet. This may occur in the L3 layer of the server computer 108. An example of the IPv6 packet is shown as 552 in FIG. 8 and includes a header and a payload. The header includes prefix fields, an IPv6 source address field and an IPv6 destination address field. The address fields include respectively IPv6 addresses of the source machine 110 and the destination machine 104. Each of the IPv6 addresses may be a private address and includes 128 bits. An example of the IPv6 source address field is shown as 554 and includes an IPv6 source address prefix fields, metadata and the IPv4 source address field. The IPv6 source address prefix fields may include, for example, version, traffic class, flow label, payload length, next header and hop limit fields. The metadata may include: a geographical location of the source machine 110; network capabilities (e.g., transmission speed, communication protocols, packet types, types of encoding, etc.) of the source machine 110; a VNET ID, a subnet ID, an IP address of a customer VM, an ID of an end application, etc. An example of the IPv6 destination address field is shown as 556 and includes an IPv6 destination address prefix field and the IPv4 destination address field with the IPv4 destination address. The IPv6 destination address prefix field may include 96 bits. The payload of the IPv6 packet includes the payload of the IPv4 packet.

At 505A, the protocol converter 112 may determine parameters of the metadata to be included in the IPv6 source address field 554. This may include determining the geographical location of the source machine 110; the network capabilities of the source machine 110; the VNET ID, the subnet ID, the IP address of a customer VM, the ID of the end application, and/or other parameters. Some or all of these parameters may be stored in memory 111. In one embodiment, 96 bits of the IPv6 source address field 554 are reserved for the metadata. In one embodiment, 16 bits of the 96 bits are reserved for the geographical location and/or region of the source machine 110. As an example, the 16 bits may indicate whether the source machine 110 is in the United States or is in another country. Of the 96 bits, 32 bits may be reserved for a virtual location identified by the VNET ID. Of the 96 bits, 16 bits may be reserved for the subnet ID. Of the 96 bits, 32 bits may be reserved for the IP address of the VM. The metadata may include geographical location of the source machine 110; the network capabilities of the source machine 110; the VNET ID, the subnet ID, the IP address of a customer VM, and/or the other parameters.

At 505B, the protocol converter 112 may generate the IPv6 source address field 554 including the determined metadata. At 505C, the protocol converter 112 may generate the IPv6 destination address field 556 to include the IPv4 destination address. The IPv4 destination address may be appended to an end of the IPv6 destination address prefix. Operation 505 may include encoding a portion or the entire IPv6 packet using a predetermined protocol.

At 506, the encapsulator 114 encapsulates the IPv6 packet. An example of the encapsulated IPv6 packet is shown as 558 in FIG. 8. The encapsulated IPv6 packet includes the IPv4 source address field, the IPv4 destination address field, an encapsulation header appended on the beginning of the IPv6 packet. The encapsulation header may include additional routing information. The IPv6 packet may be encapsulated via network visualization using generic routing encapsulation (NVGRE) or virtual extensible local area network (VXLAN) technologies. This allows the encapsulated packet to be routed and tunneled between network layers.

At 510, the source machine 110 transmits the encapsulated packet from the source machine 110 to the destination machine 104 based on the IPv4 destination address and the encapsulation header. The method may end at 512. The method of FIG. 9 may be performed subsequent to the method of FIG. 7.

FIG. 9 shows a method of operating a destination machine 104. Although the method of FIG. 9 is described with respect to the destination machine 104, the method may be implemented by other machines of FIGS. 1-6.

The method begins at 600 and may include execution of the resource management application 44 by the processor 40. At 601, the resource management application 44 may receive the policy/policy request from the customer (or source) machine 110. At 602, the resource management application 44 may create, update and/or modify the ACL based on the information in the policy/policy request. This may include creating, updating and/or modifying one or more rules of the ACL. The resource management application 44 may place the ACL at a traffic controller as described above. As an example, the ACL may be placed at the server computer 152 for use by the SQL database servicer 134 and/or the storage servicer 135.

The ACLs described herein may be endpoint ACLs created for security reasons. The ACLs provide the ability to selectively permit or deny traffic for a resource endpoint. This packet filtering capability provides a layer of security. Network ACLs may be created for endpoints (e.g., ports of resources). The ACLs include lists of rules. When an ACL is created and applied to a resource endpoint, packet filtering takes place on a host node of the resource. This means the traffic from remote IP addresses is filtered by the host node based on ACL rules. When a resource is created, a default ACL may be created to block all incoming traffic to the resource. However, it an endpoint is created for a port of the host node, then the default ACL is modified to allow all inbound traffic for that endpoint. Inbound traffic from any remote subnet is then allowed to that endpoint and no firewall provisioning is required. All other ports are blocked for inbound traffic unless endpoints are created for those ports. Outbound traffic is allowed by default. During operation 602, a pre-existing ACL may be modified and/or a new ACL may be created with one or more rules set up for access to a resource.

The ACLs allow for: selectively permitting or denying incoming traffic to a resource endpoint; blacklisting IP addresses and/or other forms of identification; creating multiple rules per resource endpoint; and/or assigning a specific ACL and/or set of ACL rules to a particular one of the parameters of the metadata. Each ACL may have a corresponding ACL table relating parameters to permit/deny access values.

At 604, the resource management application 44 may subsequently receive the encapsulated IPv6 packet from the source machine 110. The encapsulated IPv6 packet may be associated with accessing the resource. In one embodiment, this resource is a same resource as accessed by the application 118 and referred to above for operations 501-503. The encapsulated IPv6 packet may be received from, for example, one of the applications 118, 124, 130 or from another application. At 606, the de-encapsulator 138 de-encapsulates the received packet. This includes removing the IPv4 source address field, the IPv4 destination address field, and the encapsulation field.

At 608, the resource management application 44 removes the metadata from the IPv6 packet. An example of the metadata is shown as 562 in FIG. 8. The following operations 614-618 may be performed by the resource management application 44 or by one of the above-described traffic controllers to enforce the policy of the ACL.

At 614, the resource management application 44 and/or the traffic controller may determine whether the machine executing the application that sent the encapsulated IPv6 packet is permitted to access the resource based on the ACL generated, updated, and/or modified during operation 602. This may include determining if parameters of the IPv6 packet satisfy one or more rules of the ACL. This may also include determining whether one or more of the parameters associated with the request and/or the machine executing the application that sent the request match one or more of the parameters in the metadata. The comparison/evaluation of the parameters assures that the application and/or machine executing the application that generated the request are owned and/or subscribed to by a particular customer and/or are part of a particular VNET and/or subnet. This verification may also include determining whether the machine executing the application that generated the request is a particular machine and/or VM. In one embodiment, a particular application (e.g., the application 118) is permitted access and all other applications are prevented from accessing the resource.

If the requested access is permitted, operation 616 is performed to provide access to the resource. At 617, the de-encapsulated IPv6 packet may be forwarded from the application that initially received the IPv6 packet to another (or end) application, an end resource and/or machine of an end resource. This transfer may be based on the IPv4 source and/or destination addresses and/or the IPv6 source and/or destination addresses in the de-encapsulated IPv6 packet. In one embodiment, this transfer is isolated to the L7 layer. If the requested access is denied, operation 618 is performed and the access to the resource is prevented. The method may end at 620.

The above-described operations of FIGS. 7 and 9 are meant to be illustrative examples; the operations may be performed sequentially, synchronously, simultaneously, continuously, during overlapping time periods or in a different order depending upon the application. Also, any of the operations may not be performed or skipped depending on the implementation and/or sequence of events.

Although FIG. 9 is primarily described with respect to the placement of ACLs based on metadata embedded in an IPv6 packet, the metadata may be used for audit logging, domain name server translations, and/or other purposes. For audit logging, the metadata may be used, for example, when during generation of logs of when events occurred and what the events involved. For example, a log of when each VM accessed each resource. The metadata may be used to limit access to a docket key database, a data storage, a SQL database, and/or other resources.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include processor hardware (shared, dedicated, or group) that executes code and memory hardware (shared, dedicated, or group) that stores code executed by the processor hardware.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. Shared processor hardware encompasses a single microprocessor that executes some or all code from multiple modules. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

None of the elements recited in the claims are intended to be a means-plus-function element within the meaning of 35 U.S.C. § 112(f) unless an element is expressly recited using the phrase “means for” or, in the case of a method claim, using the phrases “operation for” or “step for.”

1. A system comprising:
a processor; and
a non-transitory computer-readable medium configured to store instructions for execution by the processor, wherein the instructions include
accessing a resource via a first machine in a cloud-based network, wherein the first machine is a virtual machine,
converting at the first machine an IPv4 packet to a IPv6 packet,
while converting the IPv4 packet, embedding metadata in the IPv6 packet, wherein the metadata includes information identifying at least one of the first machine or a virtual network of the first machine, and
transmitting the IPv6 packet to a second machine to limit access to the resource based on the information identifying the at least one of the first machine or the virtual network of the first machine, wherein the second machine limits access to the resource based on the information identifying the at least one of the first machine or the virtual network of the first machine.

2. The system of claim 1, wherein:
the IPv6 packet includes a header and a payload;
the header includes an IPv6 source address and an IPv6 destination address; and
the IPv6 source address includes the metadata.

3. The system of claim 2, wherein the IPv6 source address includes an IPv6 prefix.

4. The system of claim 1, wherein the instructions further include:
encapsulating the IPv6 packet to provide an encapsulated IPv6 packet, wherein the encapsulated IPv6 packet includes an IPv4 source address of the IPv4 packet, an IPv4 destination address of the IPv4 packet, and an encapsulation header; and
transmitting the encapsulated IPv6 packet to the second machine.

5. The system of claim 1, wherein the instructions further include:
determining parameters to include in the metadata, wherein the parameters include a virtual network identifier, a subnet identifier and an address of the first machine;
generating an IPv6 source address field to include the parameters; and
generating the IPv6 packet to include the IPv6 source address field,
wherein the IPv6 packet is transmitted to the second machine to limit access to the resource based on the parameters.

6. The system of claim 1, wherein the instructions further include:
determining a parameter to include in the metadata, wherein the parameter indicates a geographical location of the first machine;
generating an IPv6 source address field to include the parameter; and
generating the IPv6 packet to include the IPv6 source address field,
wherein the IPv6 packet is transmitted to the second machine to limit access to the resource based on the parameter.

7. The system of claim 1, wherein the instructions further include:
determining parameters to include in the metadata, wherein the parameters include network capabilities of the first machine;
generating an IPv6 source address field to include the parameters; and
generating the IPv6 packet to include the IPv6 source address field,
wherein the IPv6 packet is transmitted to the second machine to limit access to the resource based on the parameters.

8. The system of claim 1, wherein the second machine is in the cloud-based network.

9. A system comprising:
a processor; and
a non-transitory computer-readable medium configured to store instructions for execution by the processor, wherein the instructions include
receiving at a first machine an IPv6 packet from a second machine, wherein the IPv6 packet includes an IPv4 source address, an IPv4 destination address and metadata, wherein the metadata includes information identifying at least one of the second machine or a virtual network of the second machine, and wherein the second machine is a virtual machine,
removing the metadata from the IPv6 packet, and
applying an access control list at a traffic controller providing access to a shared resource of a cloud-based network, wherein the access control list includes one or more rules limiting access to a resource based on the information identifying at least one of the second machine or the virtual network of the second machine.

10. The system of claim 9, wherein the instructions include:
comparing the metadata to corresponding data in the access control list; and
permitting access to the resource if the metadata matches the data in the access control list.

11. The system of claim 9, wherein the traffic controller is a server computer, a host node, a fabric controller, a structured query language database servicer, or a storage servicer.

12. The system of claim 9, wherein:
the first machine includes the traffic controller; and
the instructions further include limiting access to the resource based on the access control list.

13. The system of claim 12, wherein the limiting access to the resource includes permitting an application of the second machine to access the resource and preventing other applications from accessing the resource.

14. The system of claim 9, wherein:
the metadata includes parameters;
the parameters include a virtual network identifier, a subnet identifier and an address of the second machine; and
the instructions further include applying the access control list based on the parameters.

15. The system of claim 9, wherein:
the metadata includes a parameter;
the parameter indicates a geographical location of the second machine; and
the instructions further include applying the access control list based on the parameter.

16. The system of claim 9, wherein:
the metadata includes parameters;
the parameters include network capabilities of the second machine; and
the instructions further include applying the access control list based on the parameters.

17. A non-transitory computer-readable medium storing processor-executable instructions, the instructions comprising:
accessing a resource via a first machine in a cloud-based network, wherein the first machine is a virtual machine;
converting at the first machine an IPv4 packet to an IPv6 packet;
while converting the IPv4 packet, embedding information in the IPv6 packet, wherein the information identifies at least one of a virtual network, a subnet or an Internet protocol address of the first machine; and
transmitting the IPv6 packet to a second machine to limit access to the resource based on the information identifying the at least one of the virtual network, the subnet or the Internet protocol address of the first machine, wherein the second machine limits access to the resource based on the information identifying the at least one of the virtual network, the subnet or the Internet protocol address of the first machine.

18. The non-transitory computer-readable medium of claim 17, wherein:
the IPv6 packet includes a header and a payload;
the header includes an IPv6 source address and an IPv6 destination address;
the IPv6 source address includes the information identifying the at least one of the virtual network, the subnet or the Internet protocol address of the first machine; and
the instructions further include
determining an identifier of the virtual network and an identifier of the subnet;
generating an IPv6 source address field to include the identifier of the virtual network, the identifier of the subnet and the Internet protocol address of the first machine; and
generating the IPv6 packet to include the IPv6 source address field,
wherein the IPv6 packet is transmitted to the first machine to limit access to the resource based on the identifier of the virtual network, the identifier of the subnet and the Internet protocol address of the first machine.

19. The non-transitory computer-readable medium of claim 17, wherein:
the IPv6 packet includes a header and a payload;
the header includes an IPv6 source address and an IPv6 destination address;
the IPv6 source address includes the information identifying the at least one of the virtual network, the subnet or the Internet protocol address of the first machine; and
the instructions further include
determining a geographical location of the first machine;
generating an IPv6 source address field to include the geographical location of the first machine; and
generating the IPv6 packet to include the IPv6 source address field,
wherein the IPv6 packet is transmitted to the first machine to limit access to the resource based on the geographical location of the first machine.

20. The non-transitory computer-readable medium of claim 17, wherein:
the IPv6 packet includes a header and a payload;
the header includes an IPv6 source address and an IPv6 destination address;
the IPv6 source address includes the information identifying the at least one of the virtual network, the subnet or the Internet protocol address of the first machine; and
the instructions further include
determining network capabilities of the first machine;
generating an IPv6 source address field to include the network capabilities of the first machine; and
generating the IPv6 packet to include the IPv6 source address field,
wherein the IPv6 packet is transmitted to the first machine to limit access to the resource based on the network capabilities of the first machine.
